(19) United States
(12) Patent Application Publication
(10) Pub. No.: US 2018/0089148 A1
(43) Pub. Date: Mar. 29, 2018

(54) DISTURBANCE SOURCE TRACING METHOD

(71) Applicant: Industrial Technology Research Institute, Hsinchu (TW)

(72) Inventors: Jyun-Sian Li, Kaohsiung City (TW); Yi-Cheng Cheng, Hsinchu City (TW); Chen-Kai Hsu, Miaoli County (TW); Chun-Yen Chen, Taoyuan City (TW)

(73) Assignee: Industrial Technology Research Institute, Hsinchu (TW)

(21) Appl. No.: 15/361,078

(22) Filed: Nov. 25, 2016

(30) Foreign Application Priority Data
Sep. 23, 2016 (TW) 105130759

(51) Int. Cl. G06F 17/18

(52) U.S. Cl. CPC G06F 17/18; F16K 37/00

(57) ABSTRACT

A disturbance source tracing method adapted for tracing a disturbance source of a system including a plurality of candidate nodes by a computing apparatus is provided. In this method, the computing apparatus obtains a plurality of topology information by analyzing the system using a plurality of process analyzing methods respectively. The topology information records causalities between the candidate nodes of the system. The computing apparatus applies each causality of the topology information to a probability distribution algorithm, and calculates a stationary probability distribution of each of the candidate nodes. The computing apparatus also synthesizes the stationary probability distributions calculated with respect to each process analyzing method to calculate a probability distribution of each of the candidate nodes being the disturbance source.

### CROSS-REFERENCE TO RELATED APPLICATION

This application claims the priority benefit of Taiwan application serial no. 105130759, filed on Sep. 23, 2016. The entirety of the above-mentioned patent application is hereby incorporated by reference herein and made a part of this specification.

### TECHNICAL FIELD

The disclosure relates to a disturbance source tracing method and more particularly, to a disturbance source tracing method combined with various types of topology information.

### BACKGROUND

Generally, improper parameter adjustment of each controller, wear and tear of valve members, external disturbance or other various causes in a plant may cause disturbance to loops in the plant. An oscillation disturbance is a cyclic phenomenon and usually has particular amplitude and frequency features. When the oscillation phenomenon accidentally occurs to a specific loop in the plant, the oscillation phenomenon will broaden to related loops in the periphery and even to the entire plant through influences of feedback and transmission of control signals or substances among loops, which may result in a plant wide oscillation phenomenon. As the plant wide disturbance continues, it may result in process jump, reduction of process performance, reduced product quality, increased yield loss and excess power consumption. However, when the plant wide disturbance occurs, it usually turns out to be incapability of instantly monitoring and disposal due to the numerous loops and indefinite causes.

Many techniques for searching the disturbance source have been developed, but each has disadvantages and restrictions. For example, for a disturbance phenomenon caused by a non-linear movement due to wear or adhesion of a valve member, a method of testing non-linearity based on data analysis has been currently developed. In this method, a loop with the highest non-linearity is identified by analyzing the non-linearity of each loop data and further determined as the disturbance source. However, the aforementioned method highly depends on data quality, and a range that the method is capable of analyzing is restricted to the disturbance phenomenon caused by non-linear movements.

Therefore, a disturbance source tracing method capable of accurately identifying the disturbance source of the oscillation without any restriction is necessarily developed, which facilitates engineers to quickly focus on the problematic loop for testing and diagnosis to find out the actual cause.

### SUMMARY

A disturbance source tracing method is introduced herein, which is capable of quickly and effectively identifying a disturbance source from numerous loops in oscillation occurring in a system, without being restricted to disturbances caused by specific causes.

The disturbance source tracing method introduced by the disclosure is adapted for tracing a disturbance source of a system including a plurality of candidate nodes by a computing apparatus. In the method, a plurality of topology information is obtained by the computing apparatus by analyzing the system using a plurality of process analyzing methods respectively. The topology information records a plurality of causalities among the candidate nodes of the system. Then, each causality of the topology information is applied to a probability distribution algorithm to calculate a stationary probability distribution of each of the candidate nodes. The stationary probability distributions calculated with respect to each process analyzing method is synthesized to calculate a probability distribution of each of the candidate nodes being the disturbance source to a probability distribution of each of the candidate nodes being the disturbance source.

To sum up, in the disturbance source tracing method introduced by the disclosure, the topology information recording the causalities among the candidate nodes in the system is respectively obtained by using various process analyzing methods, and then, the causalities are applied to the probability distribution algorithm to calculate the stationary probability distribution of each of the candidate nodes. Finally, the stationary probability distributions calculated with respect to each process analyzing method are synthesized to calculate the probability distribution of each of the candidate nodes being the disturbance source. In this way, the disclosure can achieve serializing the topology information analyzed with respect to the process analyzing methods into the stationary probability distributions of the candidate nodes in the system, and further achieve synthesizing the stationary probability distributions obtained with respect to each process analyzing method, so as to increase reliability and accuracy for tracing the disturbance source.

Several exemplary embodiments accompanied with figures are described in detail below to further describe the disclosure in details.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart illustrating a disturbance source tracing method according to an embodiment of the disclosure.

FIG. 2 is a schematic diagram illustrating a plurality of topology information according to an embodiment of the disclosure.

FIG. 3 is a schematic diagram of calculating a stationary probability distribution of each of the candidate nodes in the system by using the topology information according to an embodiment of the disclosure.

FIG. 4 is a schematic diagram of synthesizing each stationary probability distribution to calculate a probability distribution of each of the candidate nodes being the disturbance source according to an embodiment of the disclosure.

FIG. 5 illustrates a piping and instrument diagram (P&ID) of a system according to an embodiment of the disclosure.

FIG. 6 is a schematic diagram illustrating spectral feature analysis according to an embodiment of the disclosure.

FIG. 7 is a schematic diagram illustrating the Granger causality test method according to an embodiment of the disclosure.

FIG. 8 is a schematic diagram illustrating the transfer entropy method according to an embodiment of the disclosure.

FIG. 9 is a schematic diagram illustrating the Bayesian network method according to an embodiment of the disclosure.

FIG. 10 is a schematic diagram illustrating the P&ID method according to an embodiment of the disclosure.

### DESCRIPTION OF EMBODIMENTS

Generally speaking, when a plurality of candidate nodes in a system are analyzed by using different process analyzing methods, different causalities among the candidate nodes can be obtained, such that various topology information is obtained. The topology information may vary due to incorrect information being contained. In the disclosure, the topology information obtained with respect to the process analyzing methods are analyzed by using a probability distribution algorithm, and then, a plurality of serialized results obtained from the analysis are synthesized, so as to integrate a probability distribution of each of the candidate nodes being a disturbance source. Not only a probability of failure can be reduced by such outcome obtained by combining various methods, but also a probable disturbance transmission path can also be rendered according to the calculated probability.

The disturbance source tracing method introduced by the disclosure is adapted for a computing apparatus. The computing apparatus is an electronic device with computation capability, such as a personal computer (PC), a work station, a server, a notebook, a personal digital assistant (PDA), a smart phone and a tablet PC, which is not limited in the disclosure. In the present embodiment, the computing apparatus is capable of executing a program code implemented in a form of software or firmware, so as to perform the disturbance source tracing method introduced by the disclosure to trace a disturbance source of a system including a plurality of candidate nodes.

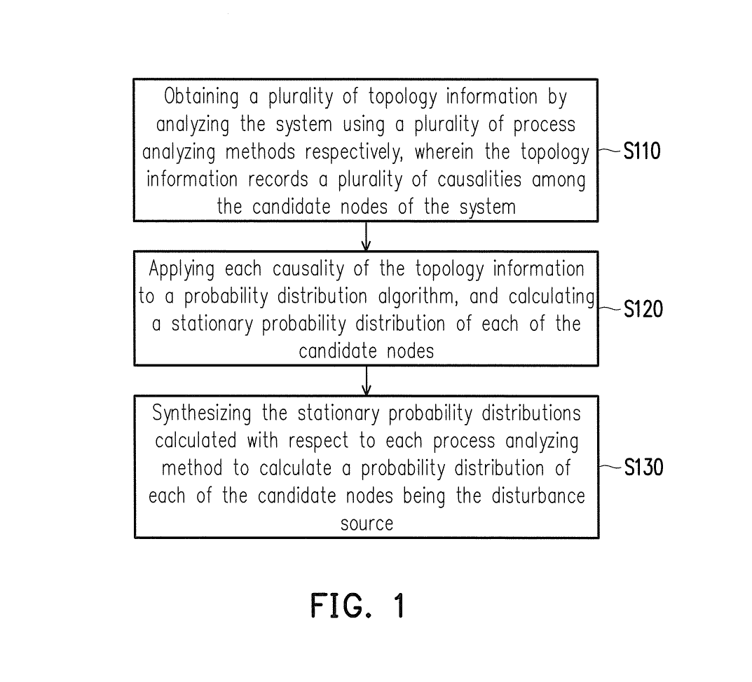

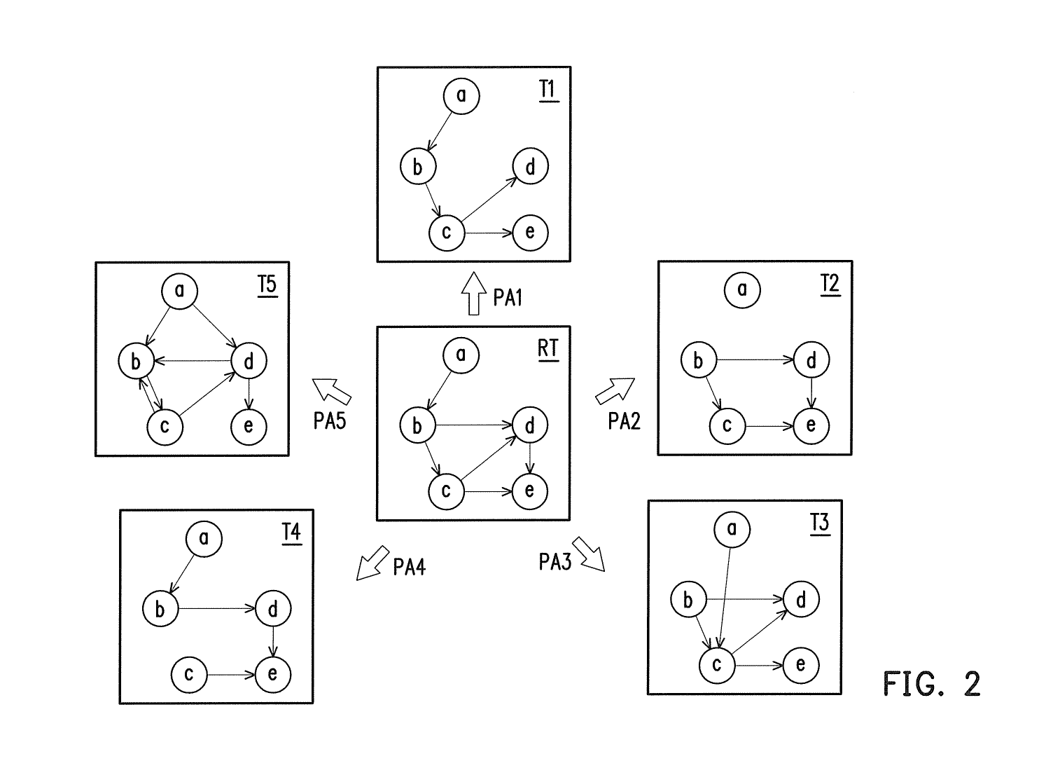

Specifically, FIG. 1 is a flow chart illustrating a disturbance source tracing method according to an embodiment of the disclosure. FIG. 2 is a schematic diagram illustrating a plurality of topology information according to an embodiment of the disclosure. Referring to FIG. 1 and FIG. 2, in step S110, the computing apparatus obtains a plurality of topology information by analyzing the system using a plurality of process analyzing methods respectively.

In the present embodiment, the system includes candidate nodes a, b, c, d, and e. For convenience, a causality between any two candidate nodes in the topology information is represented by a directed diagram in the present embodiment, topology information T1 to topology information T5 represent the topology information obtained by analyzing the system using five kinds of process analyzing methods PA1 to PA5, and topology information RT is employed to represent real topology information of the system, in which real causalities among the candidate nodes a to e are recorded.

To be detailed, the topology information T1 represents the causalities among the candidate nodes a to e obtained by analyzing the system using the process analyzing method PA1, in which oscillation from the node a influences the candidate node b, oscillation from the node b influences the candidate node c, and oscillation from the node c influences the candidate nodes d and e, while oscillation from the node d or e does not influence any other candidate nodes. The topology information T2 represents the causalities among the candidate nodes a to e obtained by analyzing the system using the process analyzing method PA2, in which the oscillation from the node a does not influence any other candidate nodes, and the oscillation from the node b influences the candidate nodes c and d, and the rest may be so deduced by analogy.

In the present embodiment, the process analyzing methods PA1 to PA5 include a data-driven method and a model-based method. Therein, the data-driven method includes, for example, a Granger causality test method, a transfer entropy method, a Bayesian network method and a cross-correlation method and so on. These methods are employed to determine mutual relationships among nodes according to the causalities among the data. On the other hand, the model-based method includes a piping and instrument diagram (P&ID) method, which is employed to integrate a connection of each pipe and equipment into a topology model through the combination of diagram data and domain knowledge.

It should be noted that the manner of the computing apparatus obtaining the topology information is not limited in the disclosure. In an embodiment, the computing apparatus may obtain the topology information T1 to T5 by, for example, analyzing the system using the five different process analyzing methods PA1 to PA5 respectively. In other embodiments, the computing apparatus may also obtain the topology information T1 to T5 in other ways.

After obtaining the topology information, in step S120, the computing apparatus applies each causality of the topology information to a probability distribution algorithm to calculate a stationary probability distribution of each of the candidate nodes in the system.

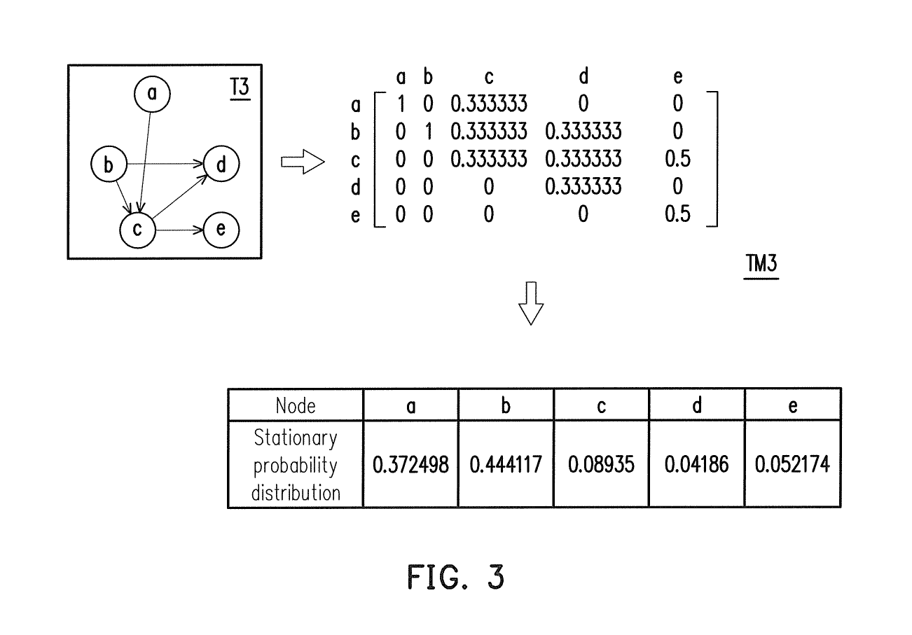

FIG. 3 is a schematic diagram of calculating a stationary probability distribution of each of the candidate nodes in the system by using the topology information according to an embodiment of the disclosure. In the present embodiment, the stationary probability distribution is calculated by using the probability distribution algorithm based on a Markov chain. Specifically, the computing apparatus first establishes an adjacency matrix of the causalities among the candidate nodes for each topology information, and then, the adjacency matrix is normalized into a Markov chain-based transition matrix. Herein, regarding how to establish the adjacency matrix and normalize it into the transition matrix, a person skilled in the art can obtain sufficient teaching based on his/her knowledge with respect to the Markov chain and thus, will not be repeatedly described.

Taking the topology information T3 depicted in FIG. 3 as an example, the computing apparatus first establishes an adjacency matrix to represent causalities among the candidate nodes in the topology information T3, and then, normalizes the established adjacency matrix into a Markov chain-based transition matrix TM3. Each element in the transition matrix is employed to represent a mutual influence relationship between each two nodes.

In the present embodiment, after obtaining the transition matrix, the computing apparatus further calculates a solution of the transition matrix in a stationary state. To be detailed, an eigen vector of the transition matrix when having a feature value of 1 may be considered as a vector solution of the transition matrix in the stationary state. Thus, when the computing apparatus iteratively calculates a numerical solution of the transition matrix in the stationary state, the computing apparatus may, for example, calculate a numerical solution of an eigen vector of the transition matrix when having an eigen value of 1 to serve the numerical solution as a stationary probability distribution of each of the candidate nodes in the system.

Referring to FIG. 3 again, the computing apparatus iteratively calculates a numerical solution of the transition matrix TM3 in the stationary state to serve the numerical solution as a stationary probability distribution of each of the candidate nodes a to e in the system. Specifically, the numerical solution of the transition matrix TM3 of the present embodiment in the stationary state is, for example, [0.372498, 0.444117, 0.08935, 0.04186, 0.052174], where 0.372498 represents a stationary probability of the candidate node a. The stationary probability may represent, for example, a probability of the candidate node a being the disturbance source in the topology information T3 obtained by analyzing the system using the process analyzing method PA3. The probability of each of other candidate nodes b to e may be so deduced by analogy and will not be repeatedly described.

It is to be mentioned that according to the topology information T3 obtained by analyzing the system using the process analyzing method PA3 solely, the candidate node b has the highest probability to be the disturbance source. Being compared with the real topology information RT depicted in FIG. 2, the right disturbance source is not determined by solely using the process analyzing method PA3. Accordingly, in the present embodiment, besides the topology information T3 corresponding to the process analyzing method PA3 is obtained, the topology information T1, T2, T4 and T5 corresponding to the other four process analyzing methods PA1, PA2, PA4 and PA5 are further obtained and synthesized to trace the disturbance source.

After obtaining the stationary probability distribution of each of the candidate nodes, in step S130, the computing apparatus synthesizes the stationary probability distribution calculated with respect to each process analyzing method to calculate a probability of each of the candidate nodes being a disturbance source.

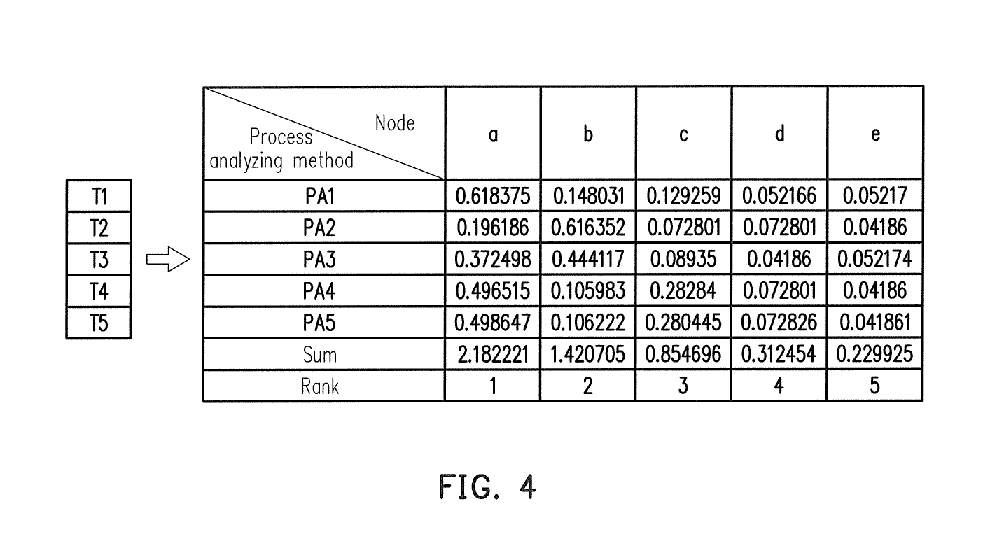

FIG. 4 is a schematic diagram of synthesizing each stationary probability distribution to calculate a probability distribution of each of the candidate nodes being the disturbance source according to an embodiment of the disclosure. In the present embodiment, the computing apparatus obtains the stationary probability distribution of each of the candidate nodes a to e in the topology information T1 to T5 corresponding to the process analyzing methods PA1 to PA5 and sums up each stationary probability distribution to serve the sum as the probability of each of the candidate node a to e being the disturbance source.

Referring to FIG. 4, in the present embodiment, in the topology information T1 obtained by analyzing the system using the process analyzing method PA1, the stationary probability distribution of each of the candidate nodes a to e is, for example, [0.618375, 0.148031, 0.129259, 0.052166, 0.05217], while in the topology information T2 obtained by analyzing the system using the process analyzing method PA2, the stationary probability distribution of each of the candidate nodes a to e is, for example, [0.196186, 0.616352, 0.072801, 0.072801, 0.04186], and the rest may be so deduced by analogy. The computing apparatus calculates a vector sum of each stationary probability distribution to serve as the probability distribution of each of the candidate nodes a to e being the disturbance source. In the present embodiment, the stationary probability distribution of each of the candidate nodes a to e is, for example, [2.182221, 1.420705, 0.854696, 0.312454, 0.229925].

It should be noted that the probability distribution of each of the candidate nodes a to e being the disturbance source is obtained by summing up five stationary probability distributions, and thus, each value therein is employed to indicate a relative probability distribution rather than an actual probability value. Thus, in the present embodiment, the computing apparatus ranks the candidate nodes a to e as [1, 2, 3, 4, 5] according to the probability distribution and thereby, determines the highest ranked candidate node (e.g., the candidate node a) as the disturbance source of the system. In another embodiment, the computing apparatus may also proportionally transform each element in the probability distribution into a vector in which a sum of each element is 1 to serve as the actual probability value of each of the candidate nodes a to e. In other words, after the probability distribution of each of the candidate nodes a to e being the disturbance source is obtained, the use of probability distribution is not limited in the disclosure.

Referring again to FIG. 2, in the present embodiment, the computing apparatus calculates the probability distribution of each of the candidate nodes a to e being the disturbance source as [2.182221, 1.420705, 0.854696, 0.312454, 0.229925] according to the topology information T1 to T5 and further determines the candidate node a as the disturbance source of the system. In comparison with the real topology information RT of the system, it is not difficult to learn that the disturbance source tracing method introduced by the disclosure can obtain a reasonable and accurate ranking result.

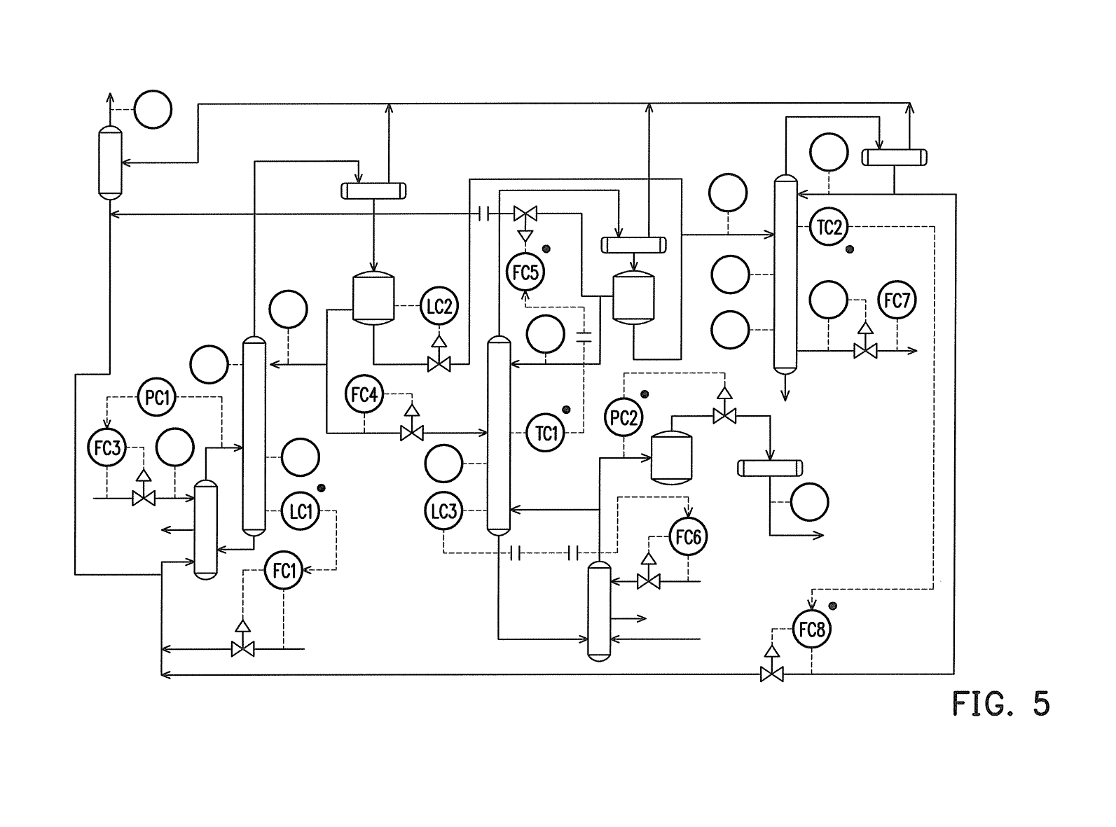

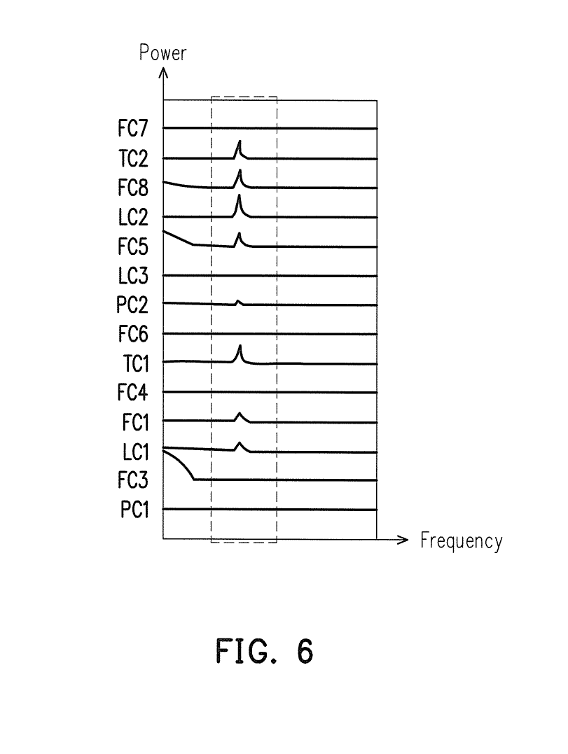

Another embodiment will be provided below for further describing the disturbance source tracing method of the disclosure. FIG. 5 illustrates a piping and instrument diagram (P&ID) of a system according to an embodiment of the disclosure. FIG. 6 is a schematic diagram illustrating spectral feature analysis according to an embodiment of the disclosure.

Referring to FIG. 5 and FIG. 6, a system includes 14 nodes FC1, FC3 to FC8, LC1 to LC3, TC1 to TC2 and PC1 to PC2. In the present embodiment, the computing apparatus first performs spectral feature analysis on the 14 nodes in the system and selects the nodes with similar spectral features as candidate nodes according to an analysis result of the spectral feature analysis. Specifically, as depicted in FIG. 6, it can be learned according to power spectra used in the spectral feature analysis that the nodes TC2, FC8, LC2, FC5, PC2, TC1, FC1 and LC1 have similar spectrum features, these nodes with the similar spectrum features may probably influence one another, and therefore, the disturbance source may be one of the nodes. Accordingly, the nodes are selected as the candidate nodes for probably being the disturbance source. In the present embodiment, the computing apparatus sets a preset value. When a difference value between two spectrum features in the spectral feature analysis is less than the preset value, the two spectrum features are determined as being similar to each other. For example, in the power spectra, if a frequency difference between power peaks of two nodes is less than the preset value, the spectrum features of the two nodes are determined as being similar. In this way, the candidate nodes that may probably be the disturbance source are selected from the plurality of nodes in the system, and then, the disturbance source of the system is traced from the candidate nodes. However, modification or adjustment may further made by the person skilled in the art depending on demands, and the manner of determining the similarity of the spectrum features is not limited in the disclosure.

After the candidate nodes are selected from the plurality of nodes in the system, the computing apparatus obtains a plurality of topology information by analyzing the system using a plurality of process analyzing methods respectively. In the present embodiment, the plurality of process analyzing methods include, for example, a Granger causality test method, a transfer entropy method, a Bayesian network method and a P&ID method.

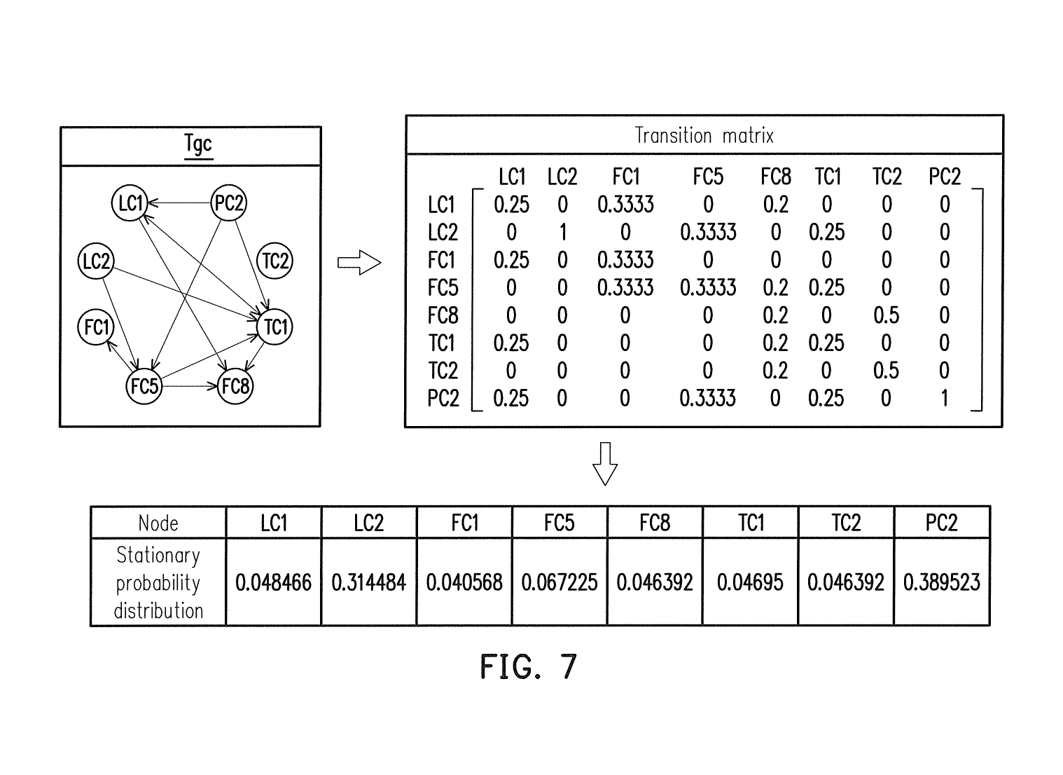

FIG. 7 is a schematic diagram illustrating the Granger causality test method according to an embodiment of the disclosure. Referring to FIG. 7, in the present embodiment, topology information Tgc may be obtained by analyzing the system using the Granger causality test method, where the topology information Tgc records causalities among the selected candidate nodes of the system. Then, the computing apparatus establishes a Markov chain-based transition matrix according to the causalities among the candidate nodes in the topology information Tgc. Each element in the transition matrix represents a mutual relationship between each two nodes. By using the transition matrix, the computing apparatus calculates a stationary probability distribution of each of the candidate nodes by iteratively calculating a numerical solution of the transition matrix in a stationary state. In the present embodiment, with the use of the Granger causality test method, a stationary probability distribution of [0.048466, 0.314484, 0.040568, 0.067225, 0.046392, 0.04695, 0.046392, 0.389523] of the candidate nodes LC1, LC2, FC1, FC5, FC8, TC1, TC2 and PC2 may be correspondingly obtained by analyzing the system based on the Markov chain.

It should be noted that in the present embodiment, the computing apparatus determines the candidate node PC2 as the disturbance source by analyzing the system using the Granger causality test method solely.

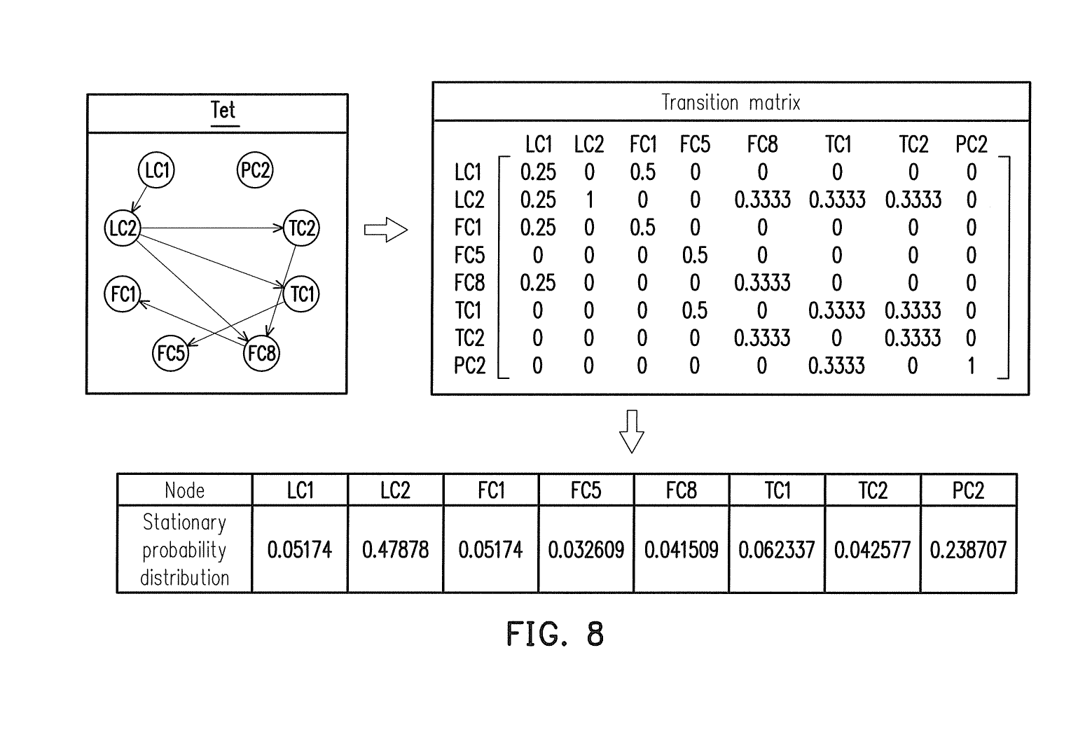

FIG. 8 is a schematic diagram illustrating the transfer entropy method according to an embodiment of the disclosure. In the present embodiment, topology information Tet may be obtained by analyzing the system using the transfer entropy method. The method of obtaining the stationary probability distribution of each of the candidate nodes from the topology information Tet is similar to the method of obtaining the stationary probability distribution of each of the candidate nodes from the topology information Tgc in the embodiment illustrated in FIG. 7, and thus, will not be repeated. In the present embodiment, a stationary probability distribution of [0.05174, 0.47878, 0.05174, 0.032609, 0.041509, 0.062337, 0.042577, 0.238707] of the candidate nodes LC1, LC2, FC1, FC5, FC8, TC1, TC2 and PC2 may be correspondingly obtained by analyzing the system using the transfer entropy method. Thus, in the present embodiment, the computing apparatus determines the candidate node LC2 as the disturbance source by analyzing the system using the transfer entropy method solely.

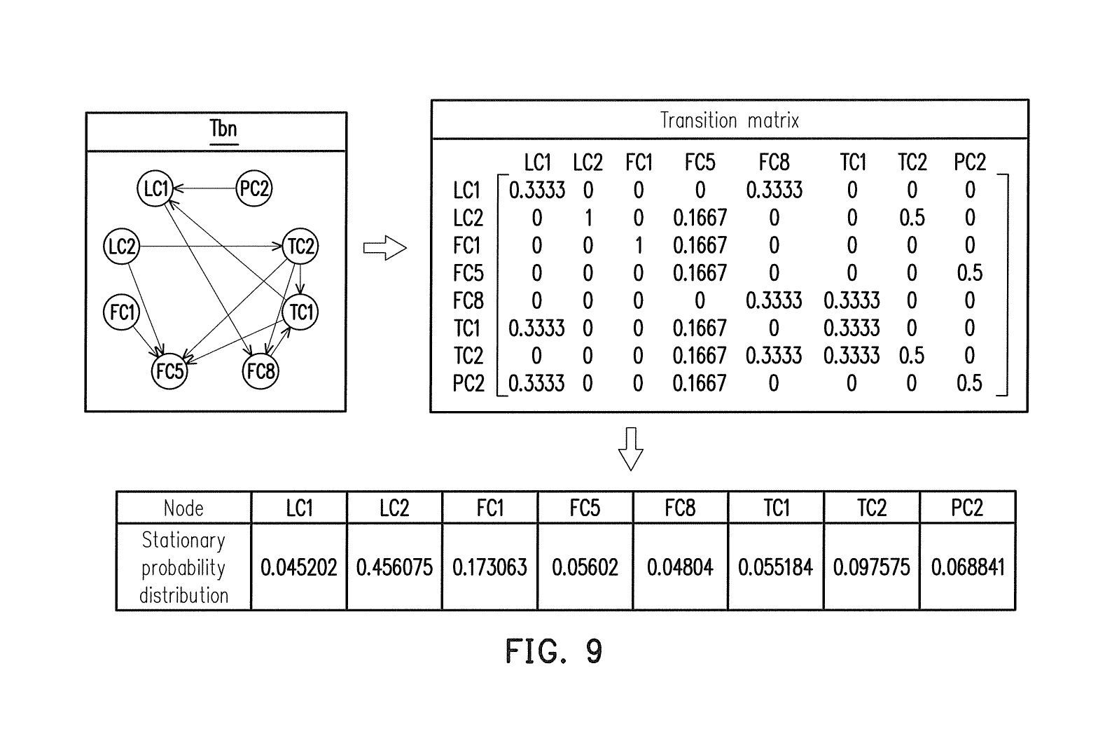

FIG. 9 is a schematic diagram illustrating the Bayesian network method according to an embodiment of the disclosure. In the present embodiment, topology information Tbn may be obtained by analyzing the system using the Bayesian network method. The method of obtaining the stationary probability distribution of each of the candidate nodes from the topology information Tbn is similar to the method of obtaining the stationary probability distribution of each of the candidate nodes from the topology information Tgc in the embodiment illustrated in FIG. 7, and thus, will not be Repeated. In the present embodiment, a stationary probability distribution of [0.045202, 0.456075, 0.173063, 0.05602, 0.04804, 0.055184, 0.097575, 0.068841] of the candidate nodes LC1, LC2, FC1, FC5, FC8, TC1, TC2 and PC2 may be correspondingly obtained by analyzing the system using the Bayesian network method. Thus, in the present embodiment, the computing apparatus determines the candidate node LC2 as the disturbance source by analyzing the system using the Bayesian network method solely.

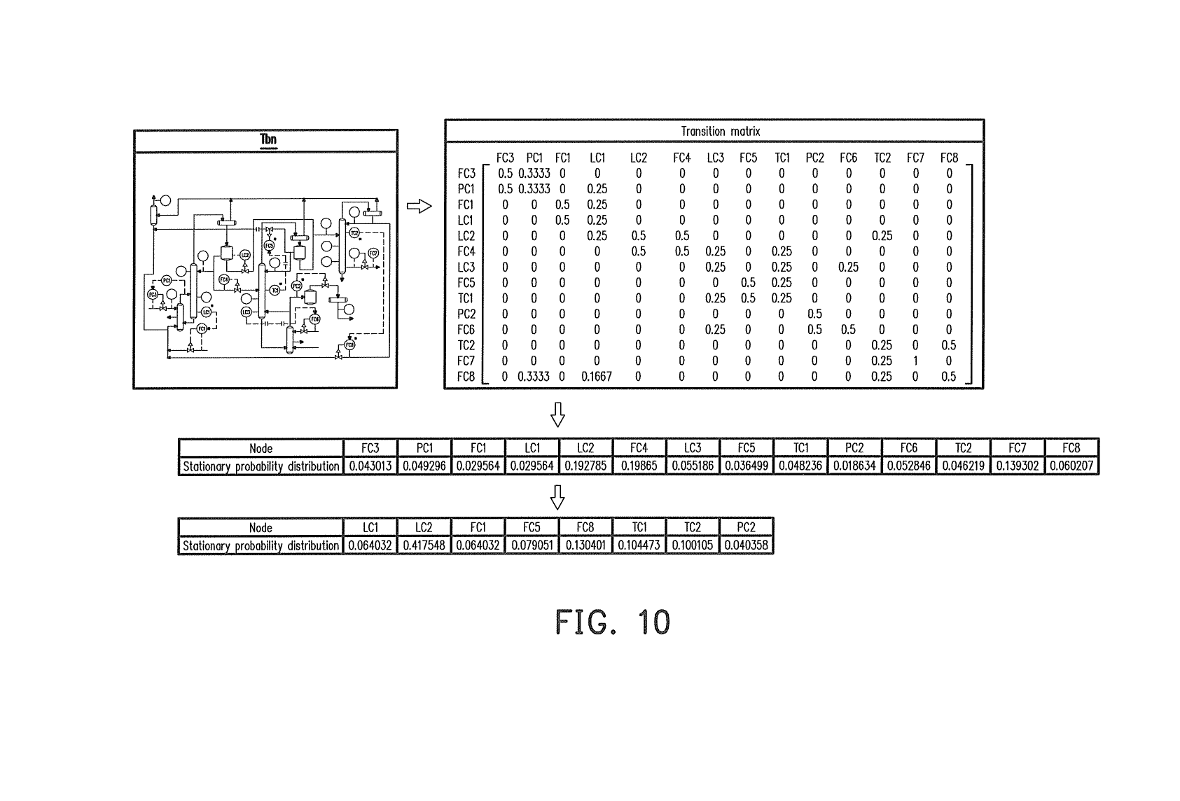

FIG. 10 is a schematic diagram illustrating the P&ID method according to an embodiment of the disclosure. In the present embodiment, topology information Tpid may be obtained by analyzing the system using the P&ID method, where the topology information Tpid records causalities among all the candidate nodes of the system. Then, the computing apparatus establishes a Markov chain-based transition matrix according to the causalities among the candidate nodes in the topology information Tpid, where each element in the transition matrix represents a mutual relationship between each two nodes. By using the transition matrix, the computing apparatus calculates the stationary probability distribution of the nodes by iteratively calculating a numerical solution of the transition matrix in the stationary state.

It is to be mentioned that the nodes in the system include the candidate nodes selected by the computing apparatus by means of the spectral feature analysis. Thus, in the present embodiment, the computing apparatus further selects the element corresponding to each of the candidate nodes from the stationary probability distributions of the nodes and proportionally adjusts the elements to render the sum thereof as 1. In this way, the elements may be employed to represent the stationary probability distribution of each of the candidate nodes in the topology information Tpid.

In the present embodiment, a stationary probability distribution of [0.064032, 0.417548, 0.064032, 0.079051, 0.130401, 0.104473, 0.100105, 0.040358] of the candidate nodes LC1, LC2, FC1, FC5, FC8, TC1, TC2 and PC2 may be correspondingly obtained by analyzing the system using the P&ID method.

Finally, the computing apparatus synthesizes the stationary probability distributions calculated with respect to each process analyzing method to calculate the probability distribution of each of the candidate nodes being the disturbance source. Referring to Table 1 below, in the present embodiment, the computing apparatus sums up and ranks the stationary probability distributions of the candidate nodes in the system. After being summed up, the stationary probability distribution of each of the candidate nodes is [0.234904, 0.266342, 0.268944, 0.286649, 0.73743]. After each of the candidate nodes is ranked according to the probability distribution, the candidate node LC2 is the highest ranked in view of the ranking result, [8, 1, 3, 7, 6, 5, 4, 2]. Thereby, the computing apparatus determines the candidate node LC2 as the disturbance source of the system.

TABLE 1

| Node | LC1 | LC2 | FC1 | FC5 | FC8 | TC1 | TC2 | PC2 |
|---|---|---|---|---|---|---|---|---|
| Granger causality test | 0.048466 | 0.314484 | 0.040568 | 0.067225 | 0.046392 | 0.04695 | 0.046392 | 0.389523 |
| Transfer entropy | 0.05174 | 0.47878 | 0.05174 | 0.032609 | 0.041509 | 0.062337 | 0.042577 | 0.238707 |
| Bayesian network | 0.045202 | 0.456075 | 0.173063 | 0.05602 | 0.04804 | 0.055184 | 0.097575 | 0.068841 |
| P&ID | 0.064032 | 0.417548 | 0.064032 | 0.079051 | 0.130401 | 0.104473 | 0.100105 | 0.040358 |
| Sum | 0.20944 | 1.666888 | 0.329403 | 0.234904 | 0.266342 | 0.268944 | 0.286649 | 0.73743 |
| Rank | 8 | 1 | 3 | 7 | 6 | 5 | 4 | 2 |

It is to be mentioned that the final ranking result is obtained according to the probability distribution of each of the candidate nodes being the disturbance source. Thus, the ranking result may also present a probable disturbance transmission path in the system. In the present embodiment, it can be learned that the disturbance may probably be transmitted on the transmission path in a sequence of LC2, PC2, FC1, TC2, TC1, FC8, FC5 and LC1 according to the ranking result. In this way, it contributes to cause diagnosis and subsequent solution of the system.

According to the present embodiment, the determination result of the disturbance source obtained by analyzing the system varies with the use of the different process analyzing methods. Specifically, the cause associated with the occurrence of the disturbance or other causes may be adapted to the use of some specific process analyzing methods in the occasion of tracing the disturbance source, or may lead to inaccuracy in some process analyzing methods. However, it is impossible to accurately consider all the causes in actual scenario of tracing the disturbance source of the system, which turns out to be difficulty in selecting the most adaptive single process analyzing method.

Generally speaking, when the disturbance source is traced by analyzing the system using the P&ID method solely, a considerable accuracy rate (e.g., 60% or more) can be achieved. Thus, among the four different kinds of process analyzing methods used in the disturbance source tracing method of the present embodiment, it is preferable that the method at least includes the P&ID method of the model-based method. Additionally, the process analyzing methods of the present embodiment are further used in collocation with other data-driven methods and synthesized with the analyzed stationary probability distributions. After the stationary probability distributions analyzed with respect to different process analyzing methods in various orientations are synthesized, the disturbance source of the system can be traced more accurately.

Based on the above, in the disturbance source tracing method of the disclosure, a plurality of topology information is obtained by analyzing the system using a plurality of process analyzing methods respectively, each causality of the topology information is applied to the probability distribution algorithm to calculate a stationary probability distribution of each of the candidate nodes, and finally, the stationary probability distributions calculated with respect to each process analyzing method are synthesized to calculate a probability distribution of each of the candidate nodes being the disturbance source. Thereby, the restriction of each process analyzing method can be excluded, such that the disturbance source can be traced more accurately. Additionally, the probability distribution of each of the candidate nodes being the disturbance source can present the probable disturbance transmission path in the system, which contributes to cause diagnosis and solution.

Although the invention has been disclosed by the above embodiments, they are not intended to limit the invention. It will be apparent to one of ordinary skill in the art that modifications and variations to the invention may be made without departing from the spirit and scope of the invention. Therefore, the scope of the invention will be defined by the appended claims.

What is claimed is:

1. A disturbance source tracing method, adapted for tracing a disturbance source of a system comprising a plurality of candidate nodes by a computing apparatus, the method comprising:
obtaining a plurality of topology information by analyzing the system using a plurality of process analyzing methods respectively, wherein the topology information records a plurality of causalities among the candidate nodes of the system;
applying each causality of the topology information to a probability distribution algorithm, and calculating a stationary probability distribution of each of the candidate nodes; and
synthesizing the stationary probability distributions calculated with respect to each process analyzing method to calculate a probability distribution of each of the candidate nodes being the disturbance source.

2. The disturbance source tracing method according to claim 1, wherein the step of applying each causality of the topology information to the probability distribution algorithm, and calculating the stationary probability distribution of each of the candidate nodes comprises:
establishing an adjacency matrix recording the causalities among the candidate nodes;
normalizing the adjacency matrix into a transition matrix; and
iteratively calculating a numerical solution of the transition matrix in a stationary state to serve as the stationary probability distribution of each of the candidate nodes.

3. The disturbance source tracing method according to claim 2, wherein the step of iteratively calculating the numerical solution of the transition matrix in the stationary state to serve as the stationary probability distribution of each of the candidate nodes comprises:
calculating an eigen vector of each transition matrix when having an eigen value of 1 to serve as the stationary probability distribution of each of the candidate nodes.

4. The disturbance source tracing method according to claim 2, wherein the step of synthesizing the stationary probability distributions calculated with respect to each process analyzing method to calculate the probability distribution of each of the candidate nodes being the disturbance source comprises:
calculating a sum of the stationary probability distribution calculated for each of the candidate nodes to serve as a probability distribution of the candidate node being the disturbance source.

5. The disturbance source tracing method according to claim 1, wherein before the step of obtaining the plurality of topology information by analyzing the system using the process analyzing methods respectively, the method further comprises:
performing spectral feature analysis on a plurality of nodes of the system; and
selecting the nodes with similar spectral features as the candidate nodes according to an analysis result of the spectral feature analysis, wherein a difference value among the spectral features of the candidate nodes is less than a preset value.

6. The disturbance source tracing method according to claim 1, wherein after the step of synthesizing the stationary probability distributions calculated with respect to each process analyzing method to calculate the probability distribution of each of the candidate nodes being the disturbance source, the method further comprises:
ranking each of the candidate nodes corresponding to the probability distribution; and
determining the candidate node which is highest ranked as the disturbance source of the system.

7. The disturbance source tracing method according to claim 1, wherein the process analyzing methods comprise a data-driven method and a model-based method.

8. The disturbance source tracing method according to claim 7, wherein the data-driven method comprises a Granger causality test method, and the model-based method comprises a piping and instrument diagram (P&ID) method.

9. The disturbance source tracing method according to claim 7, wherein the data-driven method comprises at least one of a Granger causality test method, a transfer entropy method, a Bayesian network method and a cross-correlation method.

10. The disturbance source tracing method according to claim 7, wherein the probability distribution algorithm is based on a Markov chain.
